(19) United States
(12) Patent Application Publication
(10) Pub. No.: US 2026/0154069 A1
(43) Pub. Date: Jun. 4, 2026

(54) SYSTEMS AND METHODS FOR APPLICATION PILOTING AND DEPLOYMENT

(71) Applicant: Royal Bank of Canada, Toronto (CA)

(72) Inventor: Rachel JAMES, Toronto (CA)

(21) Appl. No.: 19/401,620

(22) Filed: Nov. 26, 2025

Related U.S. Application Data
(60) Provisional application No. 63/726,742, filed on Dec. 2, 2024.

(51) Int. Cl. G06F 8/71

(52) U.S. Cl. CPC G06F 8/71

(57) ABSTRACT

Methods, systems, and techniques for piloting and deploying applications are disclosed. A computer-implemented method comprises: receiving a request to access an application from a client device; determining the application that the client device is requesting to access; determining available instances of the application; determining a target version of the application based on information specified in the request and metadata associated with the available instances of the application; and providing the client device with access to an instance of the target version of the application.

### CROSS-REFERENCE TO RELATED APPLICATIONS

This application claims priority to and the benefit of U.S. Provisional Patent Application No. 63/726,742, filed on Dec. 2, 2024, the entire contents of which is incorporated herein by reference for all purposes.

### TECHNICAL FIELD

The present disclosure relates to methods, systems, and techniques for piloting and deploying applications.

### BACKGROUND

Businesses will typically verify applications in production before being rolled out to clients (typically referred to as “piloting”). In the past, piloting applications has been performed by duplicating large numbers of applications, effectively having two environments (“live” and “pilot”), with routing between the environments controlled externally. However, having complete “live” and “pilot” production environments for a large number of applications is very costly. Further, the pilot environment typically only serves a very low amount of traffic.

Accordingly, the operational cost of running both “pilot” and “live” production environments is high, especially considering the much lower usage of the pilot environment. Piloting that involves duplicating a full set of applications and including pilot/live routing logic in a separate application may be considered acceptable with a small number of applications, as the amount of duplication is minimal, however increasing amounts of resources are unnecessarily consumed with this duplication approach when it is scaled to a larger number (e.g. hundreds) of applications.

Accordingly, methods, systems, and techniques for piloting and deploying applications remain desirable.

### SUMMARY

According to a first aspect, there is provided a computer-implemented method, comprising: receiving a request to access an application from a client device; determining the application that the client device is requesting to access; determining available instances of the application; determining a target version of the application based on information specified in the request and metadata associated with the available instances of the application; and routing the request to an instance of the target version of the application.

In some aspects, determining the target version of the application comprises parsing the request to determine a presence of information specifying the target version of the application.

In some aspects, when the request includes information specifying that the target version of the application is a target build version of the application, the method further comprises determining if the target build version of the application is available based on the metadata associated with the available instances of the application, and when the target build version of the application is available, the target build version of the application is determined to be the target version of the application.

In some aspects, the request includes information specifying that the target build version of the application is a target deployed version or a target pilot version of the application.

In some aspects, the information in the request specifying the target version of the application is associated with one or more of: a cookie, a header, and a URI path.

In some aspects, determining the target version of the application comprises parsing the request to determine a presence of information specifying full-environment piloting, and when the request includes the information specifying full environment piloting, a pilot version of the application is determined to be the target version of the application.

In some aspects, the information in the request specifying the full-environment piloting is associated with one or more of: a cookie, a header, and a URI path.

In some aspects, when the request is absent information for use in determining the target version of the application, an oldest available build version of the application is determined based on the metadata associated with the available instances of the application, and the oldest available build version of the application is determined to be the target version of the application.

In some aspects, the method further comprises: determining whether metadata associated with the application includes canary rollout information specifying a proportion of requests to be redirected from the target version of the application; and when the metadata includes the canary rollout information, redirecting the proportion of requests in accordance with the canary rollout information.

In some aspects, the method further comprises: determining available build versions of the application from the metadata associated with the available instances of the application; determining a live build version of the application as an oldest available build version of the application; and determining a pilot build version of the application as a newest available build version of the application.

In some aspects, when there is a single build version of the application, the single build version is considered as both the live build version and the pilot build version.

In accordance with another aspect of the present disclosure, there is provided a system, comprising: a processor; and a non-transitory computer-readable medium having computer-executable instructions stored thereon which, when executed by the processor, configure the system to perform the computer-implemented method of any one of the above aspects.

In some aspects, the system further comprises one or more non-transitory computer-readable mediums having computer-executable instructions stored thereon providing a plurality of applications accessible by a user device.

In some aspects, at least one of the plurality of applications comprises a pilot build version and a live build version.

In some aspects, the pilot build version and the live build version are stored in a single application namespace.

In accordance with another aspect of the present disclosure, there is provided a non-transitory computer-readable medium having computer-executable instructions stored thereon which, when executed by a processor, configure the processor to perform the computer-implemented method of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for piloting and deploying applications.

FIG. 2 is a block diagram of a server comprising part of the system depicted in FIG. 1.

FIG. 3 shows a representation of a prior art architecture for piloting and deploying applications;

FIG. 4 shows a representation of an architecture in accordance with the present disclosure for piloting and deploying applications;

FIG. 5 shows a computer-implemented method in accordance with aspects of the present disclosure; and

FIG. 6 shows a method for determining a target version of the application.

### DETAILED DESCRIPTION

In accordance with the present disclosure, methods, systems, and techniques for piloting and deploying applications are disclosed where both live and pilot versions of applications are provided in a single environment, and a pilot-aware gateway uses metadata associated with the applications to filter and determine a target version of a requested application to route requests appropriately.

In typical environments comprising a number of applications, many of the applications are not being piloted at any given time. Accordingly, because the gateway disclosed herein can determine a target version of an application for an inbound request and thus enables both live and pilot versions of applications to be provided in a single environment, the number of application copies is greatly reduced compared to previous techniques of duplicating applications in separate pilot and live environments. The methods, systems, and techniques for piloting and deploying applications as disclosed herein thus results in fewer computing resources being used, and therefore a lower operating cost.

In at least some embodiments disclosed herein, a computer-implemented method comprises: receiving a request to access an application from a client device; determining the application that the client device is requesting to access; determining available instances of the application; determining a target version of the application based on information specified in the request and metadata associated with the available instances of the application; and routing the request to an instance of the target version of the application.

In accordance with the present disclosure, application build versions can be included with each application deployment and will be seen automatically by the gateway. Multiple versions of an application can be deployed with the same service name, and the gateway can provide a route for accessing the application and filter the available instances to only those required for processing a given request. No explicit configuration needs to be done for ingress to each application, as the “live” and “pilot” versions of each application may be determined by convention.

As described above, prior approaches to per-application piloting and version control usually involve creation of a separate service for each version of an application, and explicit configuration of ingress for each application to control which service each request should target. Extensive processes tend to be built around controlling the services and ingress configuration during application piloting when using a mechanism like that. The consistency of the “configuration by convention” approach used by the gateway disclosed herein for application versioning allows for a lighter-weight piloting and rollout process and is less error-prone than other solutions.

The gateway advantageously ties together existing application discovery mechanisms and new piloting version controls to achieve full-environment and per-application piloting, as well as supports canary deployments, in a way that requires little work from application development teams.

In accordance with the methods, systems, and techniques disclosed herein, several advantages can be realized, including but not limited to:
decreased duplication of applications to only the applications that are being deployed and require production verification, rather than duplicating an entire suite of applications;
allowing piloting of a single application or a small subset of applications, rather than piloting a complete environment, which is important for improving the speed and safety of deploying and verifying urgent fixes;
extending the piloting mechanism to achieve automated, safe rollouts of new application versions (referred to as “canary deployments” or “canary rollouts”); and
extending the application discovery mechanism to all piloting-eligible applications rather than requiring manual configuration for new UI applications.

Eliminating much of the duplication of applications results in a significant cost savings (as an example, up to 50% for the relevant application groups on days when none of their applications are newly deployed). Additionally, the extra safety provided by per-application piloting (as opposed to full-environment piloting) and canary rollouts has the potential for preventing new defects from affecting clients, mitigating risk by reducing error rates and making urgent fixes safer and easier to verify. Accordingly, the various advantages described above help to provide: cost reduction; improved risk mitigation, safety, and soundness; reduced manual work (freeing development teams to better focus on delivering functionality for the business); etc.

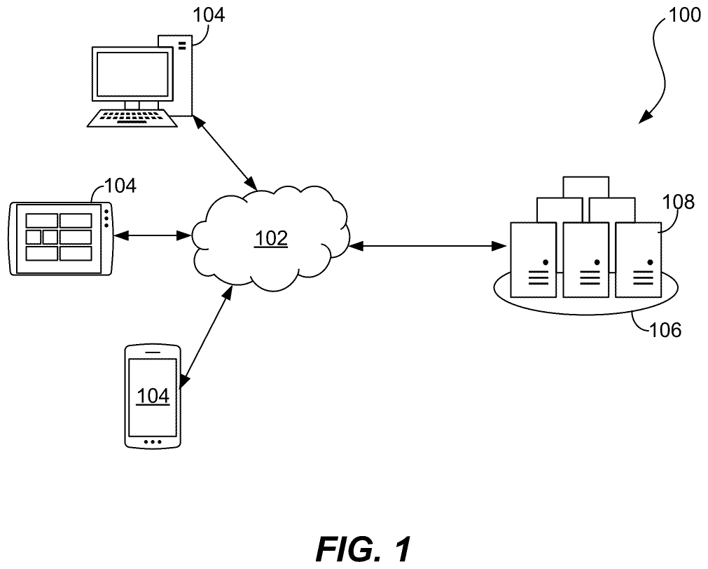

Referring now to FIG. 1, there is shown a computer network 100 that comprises an example embodiment of a system for piloting and deploying applications. The computer network 100 comprises a wide area network 102 such as the Internet to which various devices are communicatively coupled. In the example depicted in FIG. 1, the user devices 104, and data center 106 are communicatively coupled. The data center 106 comprises a number of servers 108 networked together to collectively perform various computing functions. The servers 108 may be distributed (cloud service). In accordance with the present disclosure, the servers 108 host one or more applications that are accessible by user devices 104. In the context of a financial institution, for example, the servers 108 may host one or more banking applications that the user devices 104 can access to perform online banking. As described in more detail below, the servers 108 are configured to pilot and deploy the applications without needing to duplicate applications or running both a pilot and live environment.

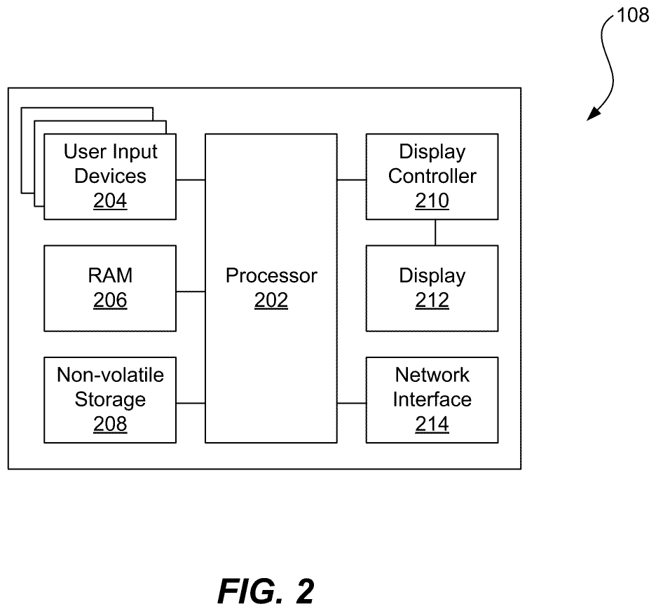

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method used for piloting and deploying applications, such as is described in more detail herein below. Additionally or alternatively, the servers 108 may collectively perform that method using distributed computing. While the system depicted in FIG. 2 is described specifically in respect of one of the servers 108, analogous versions of the system may also be used for the user devices 104.

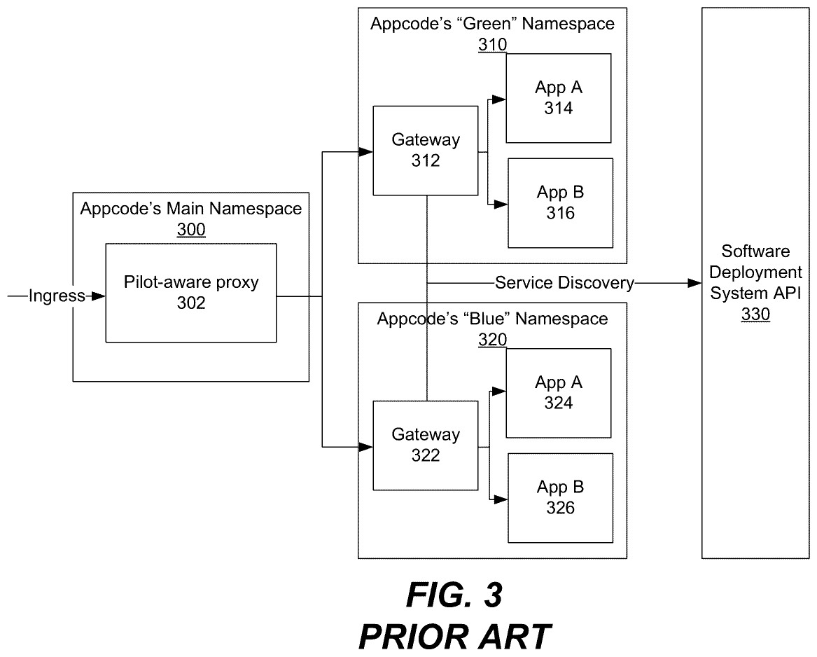

FIG. 3 shows a representation of a prior art architecture for piloting and deploying applications. As described above, piloting applications has previously been achieved by duplicating large numbers of applications to provide two environments: “live” and “pilot”, with routing between the environments controlled externally.

As shown in FIG. 3, two environments respectively providing a live and pilot environment of applications are denoted as Appcode's “Green” Namespace 310, and Appcode's “Blue” Namespace 320. Each of the namespaces comprise a gateway 312, 322, a version of Application A 314, 324, and a version of Application B 316, 326. In the live environment, e.g. Appcode's “Green” Namespace 310, the versions of Application A and Application B would be the live build versions of these applications. In the pilot environment, e.g. Appcode's “Blue” Namespace 320, the versions of Application A and Application B would be the pilot build versions of these applications.

A request to access an application is received at a pilot-aware proxy 302 of an Appcode's Main Namespace 300, as shown by the arrow denoted “Ingress”, and the pilot-aware proxy 302 is configured to direct the request to a gateway of the appropriate namespace for either the live or pilot environment. The gateways 312 and 322, upon receipt of the request forwarded from the pilot-aware proxy 302, may perform service discovery by accessing an API of a software deployment system 330 that manages the deployment of applications, such as accessing Kubernetes™ API, to determine what applications are deployed in their respective namespace. The gateways 312 and 322 can thus direct the request to the appropriate application.

Accordingly, as represented in FIG. 3, this prior approach for piloting and deploying applications requires two environments (i.e. a live environment and a pilot environment), and requires the pilot-aware proxy to direct requests to the appropriate environment. Providing two environments typically involves duplicating applications. For example, Application A may have a live build version and a pilot build version, but Application B may only have a single live build version that is deployed. However, to provide the pilot environment (e.g. as represented by Appcode's “Blue” Namespace 320 in FIG. 3), Application B needs to be duplicated. It will be appreciated that while FIG. 3 shows a simplified architecture supporting just two applications, such environments often contain hundreds of applications, most of which are not being piloted at any given time. Accordingly, for each application that does not have a separate pilot build version, duplication of that application is performed for the pilot environment, resulting in the use of more computing resources and a higher operating cost.

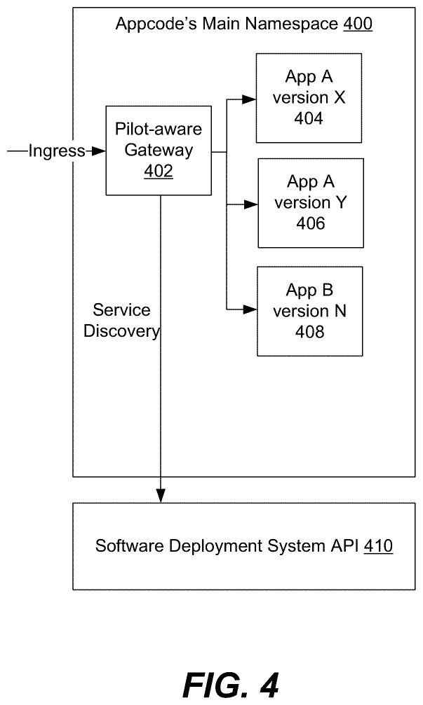

On the other hand, FIG. 4 shows a representation of an architecture in accordance with the present disclosure for piloting and deploying applications. As shown in FIG. 4, there is a single environment, namely Appcode's Main Namespace 400. Application A has two versions deployed, namely Application A version X 404, which is the “live” build version, and Application A version Y, which is the “pilot” build version. Application B has only a single version deployed, namely Application B version N 408, which is considered to be both the live and pilot build versions. Importantly, in this architecture, there is no duplication of Application B, and therefore no extra resources are needed to run a second copy of Application B.

In accordance with the architecture for piloting and deploying applications shown in FIG. 4, a pilot-aware gateway 402 is configured to route an incoming request to an appropriate target version of a requested application. The target version of the application is determined based on information specified in the request and metadata associated with the available instances of that application.

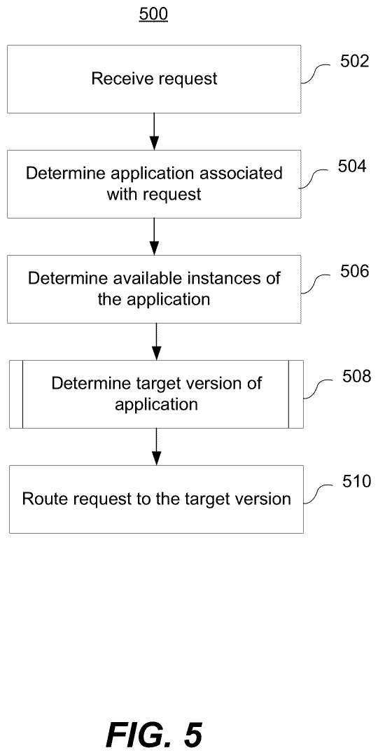

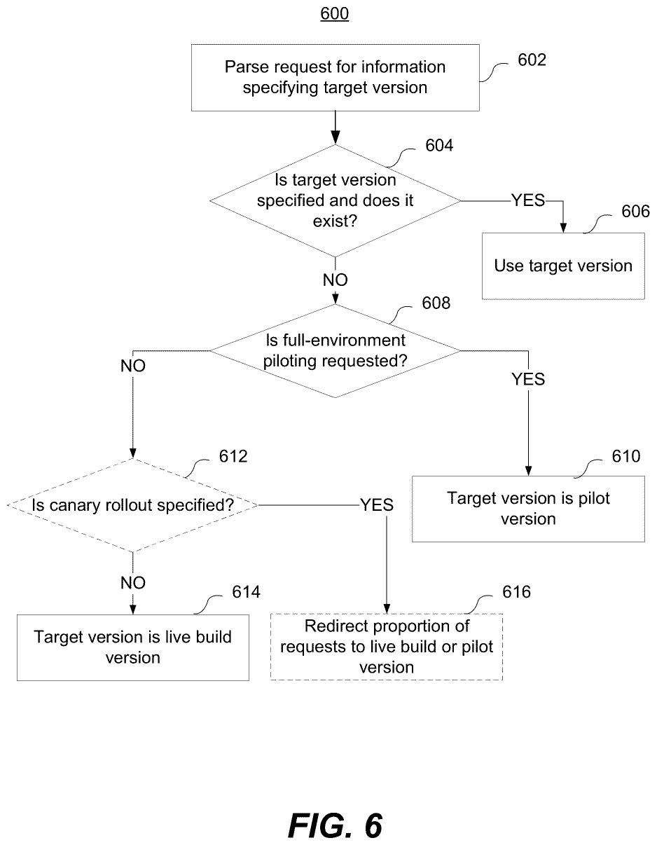

When a request is received, as shown by the arrow denoted “Ingress”, the pilot-aware gateway 402 determines which application is being targeted by the request and gathers information about the available instances of that target application by communicating with an API of the software deployment system 410 (e.g. a Kubernetes™ API). The pilot-aware gateway 402 then determines the target version of the application by filtering the application instances to only those that are being targeted by the request based on build version metadata, as well as information included in the request when available. The pilot-aware gateway 402 forwards the request to one of the remaining instances determined to be the target version of the application. Methods performed by the pilot-aware gateway to handle an incoming request and to determine the target version of the application are described in more detail below with reference to FIGS. 5 and 6.

By convention, “live” instances of an application are the ones with the oldest available build version, and “pilot” instances of the application are those with the newest available build version. If there is only one version of an application available, it may be considered as both the “live” and “pilot” build version. The consistency of the “configuration by convention” approach used by the gateway 402 for application versioning allows for a lighter-weight piloting and rollout process. It will also be appreciated however that there may be multiple build versions of an application that are deployed, and a request may specify a particular build version that has been deployed as a target version of the application.

Using the pilot-aware gateway functionality that can perform filtering to determine a target version of an application based on application metadata advantageously allows for piloting and deploying applications in a single environment and avoids duplicating copies of applications that do not have separate pilot versions. When the total number of applications owned by a development team is large, the proportion of their applications that do not have separate pilot versions at any given time tends to be large, as discussed above. Accordingly, significant savings of computational resources and cost can be attained using the pilot-aware gateway 402 disclosed herein. In addition, compared to the prior architecture as shown in FIG. 3, the architecture disclosed herein does not require a separate application in front (i.e. the pilot-aware proxy 302) to determine which environment to direct requests to.

The pilot-aware gateway 402 may be implemented using Spring Cloud Gateway, Spring Cloud Discovery, and Spring Cloud Load Balancer libraries. As described above, the pilot-aware gateway 402 performs application discovery and implements piloting functionality based on the build version metadata for each discovered instance of an application. The build version metadata's location is dependent on the Spring Cloud Discovery mechanism being used. When using Kubernetes-based discovery this comes from the Kubernetes pod definition, while other discovery methods (like Eureka-based discovery) may use metadata from active application registration.

FIG. 5 shows a computer-implemented method 500 in accordance with aspects of the present disclosure. The computer-implemented method 500 may in particular be implemented by the pilot-aware gateway 402 for applications that are being piloted and deployed in accordance with the architecture as shown in FIG. 4.

The method 500 comprises receiving a request to access an application from a client device (502). A determination is made as to which application the client device is requesting to access (504), based on information contained in the request.

Available instances of the application are determined (506). The available instances of the application may be determined by accessing the software deployment system API 410 as described with reference to FIG. 4. In determining the available instances of the application, available build versions of the application may be determined from the metadata associated with the available instances of the application, which may be used for determining a target version of the application and for directing the request, as described below. In particular, a convention may be used that determines a live build version of the application as an oldest available build version of the application, and a pilot build version of the application as a newest available build version of the application. When there is a single build version, the single build version is considered as the live build version and the pilot build version.

A target version of the application is determined based on information specified in the request and metadata associated with the available instances of the application (508). A method for determining the target version of the application is described in more detail with reference to FIG. 6. In general, the determination of the target version of the application may comprise:
The list of available build versions for the target application is extracted from application instance metadata. The oldest build version is considered the “live build version”, and the newest build version is considered the “pilot build version”.
If the request has included information about a specific targeted build version for the application (e.g. via a cookie or header), and that build version is available, this build version is considered the target version.
If the request has included information (e.g. via a cookie, header, or URI path) that the request is for the pilot build version of an application, regardless of which application is being targeted (i.e. full environment piloting), then the pilot build version is considered the target version.
Otherwise, the live build version of the application is considered the target version.

The request is routed to an instance of the target version of the application (510). That is, once the target version is determined, then the application instances are filtered to only those with matching build version metadata, and the request is routed to an instance with the matching build version metadata.

FIG. 6 shows a method 600 for determining the target version of the application. The method 600 may be performed by the gateway as part of the method 500 for determining the target version of the application at 508.

The method 600 comprises parsing the request to determine a presence of information specifying the target version of the application (602). Information in the request specifying the target version of the application may be associated with one or more of: a cookie, a header, and a URI path.

A determination is made as to whether the target version is specified, and if so, whether that target version of the application exists (604). If the request includes information specifying that the target version of the application is a target build version of the application, and if that target build version of the application is available/exists (as determined based on the metadata associated with the available instances of the application) (YES at 604), then the target build version of the application is determined to be the target version of the application (606). The information specifying the target version of the application may specify a target deployed (i.e. non-pilot) version of the application or a target pilot version of the application.

If a target version of the application is not specified in the request (NO at 604), a determination is made as to whether the request contains information specifying full-environment piloting (608). The information in the request specifying the full-environment piloting may be associated with one or more of: a cookie, a header, and a URI path. If full-environment piloting has been requested (YES at 608), then the pilot version of the application is determined to be the target version of the application (610). Again, the pilot version of the application may be identified by convention as the newest available build version of the application, based on the metadata associated with the instances of the application. If full-environment piloting has not been requested (NO at 608), and thus the request is absent any information for use in determining the target version of the application, the live build version of the application may be determined to be the target version of the application (614). Again, the live build version of the application may be determined by convention as the oldest available build version of the application, based on the metadata associated with the instances of the application.

However, if canary rollout support has been enabled in the gateway, a different target version of the application may be determined. In particular, if no target version is specified in the request (NO at 604), and if full-environment piloting is not specified in the request (NO at 608), a determination may be made as to whether metadata associated with the application includes canary rollout information specifying a proportion of requests to be redirected from the live build version of the application to a pilot build version of the application (612). When the metadata includes the canary rollout information (YES at 612), a proportion of requests may be directed between the live build and pilot versions of the application as specified in the canary rollout information (616). If no canary rollout information is specified (NO at 612), the live build version of the application may be determined to be the target version of the application (614).

Thus, if the application's metadata includes canary rollout information, then some proportion or percentage (based on that canary rollout information) of the requests that would normally be routed to the live build version of the application will instead be routed to the pilot build version. Canary rollouts advantageously allow for monitoring of error rates as an application is rolled out, and rollbacks could potentially be done in this situation by removing canary rollout information from the application's metadata.

Example use cases and implementation details for the methods, systems, and techniques disclosed herein for piloting and deploying applications are now described.

Discovery with Single-Environment Piloting Awareness

In this use case, there is only one logical environment, but there can be multiple versions of the same application discovered and exposed by the gateway, as for example represented in FIG. 4. Piloting awareness can be enabled by setting the appropriate configuration property to true. This functionality uses build information from the service instances and piloting information from the request's cookies to direct requests to “live” or “pilot” versions (or a specific build version) of the desired application.

The build information in service instances is contained in the service instance's metadata. This is taken from the metadata in the service registration. When using Kubernetes™ for service discovery, the pod's metadata is considered along with the metadata in the service itself. The build information for the service instances can be compared using the gateway's configure bean. By convention, the “live” (or “default”) version of an application exposed by the gateway is the one with the oldest build information among those discovered, based on build information included in the service instance metadata. The “pilot” version is the one with the newest build information. Note that in many situations, this means the “live” and “pilot” versions of an application will be identical.

Forced piloting can be enabled by setting the appropriate configuration property to true. This functionality allows an external web service to be used to specify whether all requests should be sent to the pilot version of the desired application, regardless of any other piloting considerations. The URL of this web service is specified by the appropriate configuration property, and it is expected to return a response body that can be parsed as a boolean value. Forced piloting may also be indicated by something other than an external web service.

Piloting information for a given request falls into two categories: full-environment piloting and per-application piloting. Full-environment piloting is used to specify the piloting strategy across all applications that are accessed through the gateway, while per-application piloting allows callers to override that strategy by specifying the desired version (build information) for specific applications.

Per-application piloting for a request can be indicated via a cookie. This can be enabled by setting the appropriate configuration property to true. The per-application piloting cookie name can be specified by setting the appropriate configuration property. Per-application piloting for a request can also be indicated via a non-cookie header. This can be enabled by setting the appropriate configuration property to true. If both the cookie and header are found, the header value may be used and the cookie value may be ignored, or vice versa.

The per-application piloting information (either in a cookie or a header) may contain a JSON object that has been Base64-encoded. This object may contain keys that match the names of applications as registered, and the associated values are the target version (build information) for each application.

If the per-application piloting information is found, and it contains a key/value pair for the application targeted by the current request, and the value is found in the build information for some instance of that application, then the request will be directed to one of the matching instances of the application. Otherwise, the gateway falls back to using the full-environment piloting information to determine to which application instances the request should be directed.

For clarity, here's an example of a per-application piloting value that has been Base64-decoded. It contains entries for two applications:

```
{
  “thefirstapp”: “20230403-14:07:53-1.0.2”,
  “application-x”: “20230402-13:41:22-2.4.12”:
}
```

Full-environment piloting for a request can be indicated by a cookie, referred to here as the “full-environment piloting cookie”. Depending on configuration, it can also optionally be indicated by the inclusion of a specific header, a hostname in the request headers, or by the URI path matching a specific pattern. The gateway is also extensible so that other full-environment piloting methods can be plugged in if needed.

If full-environment piloting is requested, then: the URI will be rewritten if necessary; a full-environment piloting cookie will be included in the response if cookies can be used to specify full-environment piloting; and the request will be directed to a “pilot” instance of the application. Otherwise, the request will be directed to a “live” instance.

“Live” instances of an application are the instances that have the smallest build information value (using the gateway's configured comparator<string> bean) among instances of that application. “Pilot” instances have the largest build information value among the instances.

To enable full-environment piloting via cookie, the appropriate configuration property is set to the value true. The full-environment piloting cookie name can be specified by setting the appropriate configuration property. The cookie contains a simple value. If that value matches the configured piloting value (specified using the configuration property), then full-environment piloting has been requested.

If cookie-based full-environment piloting has been enabled, then any time full-environment piloting has been requested (whether requested via a cookie or by any other means) an appropriate header may be added to the response that will serve as a sort of “keep-alive” for the user's piloting session if they are accessing the gateway via a browser. If a full-environment piloting cookie is included in the response via this mechanism, the values in the cookie are specified by the appropriate configuration properties.

To enable full-environment piloting via header, the appropriate configuration property is set to the value true. The full-environment piloting cookie name can be specified by setting the appropriate configuration property. The header may contain a simple value, and if that value matches the configured piloting value (specified using the configuration property), then full-environment piloting has been requested.

To allow full-environment piloting via a specific hostname in the request headers, the appropriate configuration property is set to true. If enabled, the gateway will also look at specific headers (e.g. a list specified using the configuration property) to determine full-environment piloting. The gateway will attempt to interpret the header values as URLs and extract the hostname from them, using the full header values as hostnames if they cannot be interpreted as URLs. If any of hostnames extracted from the headers include specific values (a list specified using the configuration property), then full-environment piloting has been requested.

To allow full-environment piloting via request URI path pattern matching, the appropriate configuration property is set to true. If enabled, the gateway will check to see if the request URI path matches a specific pattern (specified using the configuration property), then full-environment piloting is requested. The request URI may then be rewritten according to the replacement pattern (specified using the configuration property) before the request is further interpreted by the gateway. For example, the pattern may match the strings “-pilot” or “-pilotenv” at the end of the second path component (delineated by/), and the replacement removes the “-pilot” or “-pilotenv” portion.

Accordingly, a request may specify full-environment piloting in different manners. A cookie (referred to as the “full-environment piloting cookie”) can be included in the request, that indicates whether the “pilot” versions should be used by default for any service being accessed. This is enough for most situations, so that users can access pilot application versions for verification purposes. It is also possible to enable full-environment piloting when a specific header is found with a value that indicates full-environment piloting, when specific hostnames are found in the request headers, or when the request URI path matches a particular pattern. If cookie-based full-environment piloting is enabled, then in all situations where full-environment piloting is requested, a full-environment piloting cookie may be sent back in the response, as a sort of “keep-alive” mechanism to ensure that subsequent requests in the user's session also use full-environment piloting.

The full-environment piloting mechanism can be overridden with another request cookie or header (the “per-application piloting cookie/header”) that includes a list of specific applications and the versions that should be accessed for those applications. This allows for situations like a hotfix, where a new version of a specific application needs to be verified along with live versions of all other applications. It also allows for multiple versions of an application to exist in the same environment if needed, with the per-environment piloting value allowing for access to versions that are neither the “live” nor “pilot” versions. When using this mode of operation, a specific “non-live” version of an application may be made into the “live” version by deleting or stopping all older versions of the application.

Discovery with Single-Environment Piloting Awareness and Canary Rollout Support

This use case is similar to the discovery with single-environment piloting awareness as described above, except that it also supports canary rollouts, where a new application can be rolled out over time instead of all at once. If this piloting awareness is enabled, then canary rollout support can also be enabled by setting the appropriate configuration property to true. This functionality adds support for canary rollouts using metadata present in the service instances when a pilot version hasn't been explicitly requested.

The main difference from the previous discovery with single-environment piloting awareness is that, instead of just defaulting to the “live” version of the application when no pilot version is requested, a list of canary rollout versions and their associated weights (specified in service metadata) is consulted to determine which application version the request should be directed to.

If canary rollout support is enabled, and no pilot or non-live version has been explicitly requested via full-environment or per-application piloting, then the service instances will be examined for canary rollout metadata. The key for this metadata is specified by the appropriate configuration property.

If no canary rollout metadata is found for the service, then the request will be directed to a “live” instance of the application. If it is found and valid, then the request is directed to one of the instances involved in the rollout, using the weights given in the metadata.

Valid canary rollout metadata contains information about what weights or proportions to give the available versions when determining which instances a request should be directed to. This could be an arbitrary ratio (for example, 5 to live and 2 to pilot) or a percentage (for example, pilot instances get 40% of the traffic).

Below are some examples of canary rollout metadata:
{: live”: 3, “pilot”: 1} This example shows a ratio of 3 live to 1 pilot, meaning that 75% of requests will hit the “live” (oldest) version and 25% will hit the “pilot” (newest) version.
{“pilot”: 15} This is an example of specifying a percentage of requests that should hit the pilot version of the application, resulting in 15% of requests hitting the pilot version, and 85% hitting the live version.
{“live”: 0, “pilot”: 1} This example indicates that no requests should hit the “live” (oldest) version, and all requests should hit the “pilot” version being rolled out.
{“versions”: {“v15”: 3, “v16”: 2}} This example indicates that 60% of requests should hit instances with build information matching “v15”, and 40% of requests should hit instances with build information matching “v16”.
{“live”: 3, “versions”: {“v16”: 2}} Assuming that there are instances available that match the build info “v16”, and that the “live” version's build info is older than this, then this example indicates that 60% of requests should hit “live” instances, and 40% of requests should hit instances with build information matching “v16”.

Canary rollout support allows for a staged rollout where an increasing proportion of traffic can be directed to a new application version, with rollback (in case of a problem) being as simple as deleting the canary metadata from the service definition. Once a new version is 100% rolled out without issues, and it's determined that rollback is not necessary, then the old version of the application can be deleted or stopped, and the canary rollout information can be removed (because the new version being rolled out is now the “live” version).

It should be noted that this method of canary rollout is not effective if using Eureka for service discovery, and should not be enabled if that is the case. This is due to the fact that the canary rollout metadata is coming from the service instances, and Eureka's active registration would require all application instances to register with the correct (and same) canary rollout metadata. When using Kubernetes for discovery, the metadata can be updated in the service definition without affecting any of the running pods, making this method of canary deployment ideal for this case.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the foregoing description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computer-implemented method, comprising:
receiving a request to access an application from a client device;
determining the application that the client device is requesting to access;
determining available instances of the application;
determining a target version of the application based on information specified in the request and metadata associated with the available instances of the application; and
routing the request to an instance of the target version of the application.

2. The computer-implemented method of claim 1, wherein determining the target version of the application comprises parsing the request to determine a presence of information specifying the target version of the application.

3. The computer-implemented method of claim 2, wherein when the request includes information specifying that the target version of the application is a target build version of the application, the method further comprises determining if the target build version of the application is available based on the metadata associated with the available instances of the application, and when the target build version of the application is available, the target build version of the application is determined to be the target version of the application.

4. The computer-implemented method of claim 3, wherein the request includes information specifying that the target build version of the application is a target deployed version or a target pilot version of the application.

5. The computer-implemented method of claim 2, wherein the information in the request specifying the target version of the application is associated with one or more of: a cookie, a header, and a URI path.

6. The computer-implemented method of claim 1, wherein determining the target version of the application comprises parsing the request to determine a presence of information specifying full-environment piloting, and when the request includes the information specifying full environment piloting, a pilot version of the application is determined to be the target version of the application.

7. The computer-implemented method of claim 6, wherein the information in the request specifying the full-environment piloting is associated with one or more of: a cookie, a header, and a URI path.

8. The computer-implemented method of claim 2, wherein when the request is absent information for use in determining the target version of the application, an oldest available build version of the application is determined based on the metadata associated with the available instances of the application, and the oldest available build version of the application is determined to be the target version of the application.

9. The computer-implemented method of claim 8, further comprising:
determining whether metadata associated with the application includes canary rollout information specifying a proportion of requests to be redirected from the target version of the application; and
when the metadata includes the canary rollout information, redirecting the proportion of requests in accordance with the canary rollout information.

10. The computer-implemented method of claim 1, further comprising:
determining available build versions of the application from the metadata associated with the available instances of the application;
determining a live build version of the application as an oldest available build version of the application; and
determining a pilot build version of the application as a newest available build version of the application.

11. The computer-implemented method of claim 10, wherein when there is a single build version of the application, the single build version is considered as both the live build version and the pilot build version.

12. A system, comprising:
a processor; and
a non-transitory computer-readable medium having computer-executable instructions stored thereon which, when executed by the processor, configure the system to perform a computer-implemented method comprising:
receiving a request to access an application from a client device;
determining the application that the client device is requesting to access;
determining available instances of the application;
determining a target version of the application based on information specified in the request and metadata associated with the available instances of the application; and
routing the request to an instance of the target version of the application.

13. The system of claim 12, further comprising one or more non-transitory computer-readable mediums having computer-executable instructions stored thereon providing a plurality of applications accessible by a user device.

14. The system of claim 13, wherein at least one of the plurality of applications comprises a pilot build version and a live build version.

15. The system of claim 14, wherein the pilot build version and the live build version are stored in a single application namespace.

16. A non-transitory computer-readable medium having computer-executable instructions stored thereon which, when executed by a processor, configure the processor to perform a computer-implemented method comprising:
receiving a request to access an application from a client device;
determining the application that the client device is requesting to access;
determining available instances of the application;
determining a target version of the application based on information specified in the request and metadata associated with the available instances of the application; and
routing the request to an instance of the target version of the application.

17. The non-transitory computer-readable medium of claim 16, wherein determining the target version of the application comprises parsing the request to determine a presence of information specifying the target version of the application.

18. The non-transitory computer-readable medium of claim 17, wherein when the request includes information specifying that the target version of the application is a target build version of the application, the method further comprises determining if the target build version of the application is available based on the metadata associated with the available instances of the application, and when the target build version of the application is available, the target build version of the application is determined to be the target version of the application.

19. The non-transitory computer-readable medium of claim 18, wherein the request includes information specifying that the target build version of the application is a target deployed version or a target pilot version of the application.

20. The non-transitory computer-readable medium of claim 17, wherein the information in the request specifying the target version of the application is associated with one or more of: a cookie, a header, and a URI path.
